(19) United States
(12) Patent Application Publication
(10) Pub. No.: US 2008/0318594 A1
(43) Pub. Date: Dec. 25, 2008

(54) Pre-Location Method and System For Assisting Satellite Radio Navigation Systems

(75) Inventor: Michel Monnerat, L'Union (FR)

Correspondence Address: SUGHRUE MION, PLLC, 2100 PENNSYLVANIA AVENUE, N.W., SUITE 800, WASHINGTON, DC, 20037, US

(73) Assignee: Alcatel Lucent, Paris (FR)

(21) Appl. No.: 11/993,596

(22) PCT Filed: Dec. 13, 2006
(86) PCT No.: PCT/FR2006/051345

§ 371 Date: Jun. 22, 2008

(30) Foreign Application Priority Data
Dec. 20, 2005 (EP) 05301083.1

(51) Int. Cl. H04Q 7/20; G01S 1/00

(52) U.S. Cl. 455/456.1; 342/357.1

(57) ABSTRACT

The invention relates to a satellite radio navigation terminal using services of a cellular communication network, wherein the pre-location consists in locating the terminal in at least one network cell and the inventive method consists in forming a database (24) compiling location information items of the network cells transmitted by the cellular network terminals (4), wherein said database comprises, for each cell, at least one identifier and information item on the location thereof, and in pre-locating (23) the terminal according to the identifier thereof and information items contained in the database. Satellite positioning systems combining satellite communication techniques and satellite locating techniques such as, for example A-GPS system, are also disclosed.

This invention concerns a pre-location method and system for assisting satellite radio navigation systems. The invention also concerns a mobile telephony terminal equipped with a satellite radio navigation reception system. Satellite positioning systems combining satellite communication techniques and satellite locating techniques such as the A-GPS system, for example, are also disclosed.

Location services are becoming increasingly important in telecommunications applications. RNSS (Radio Navigation Satellite Service) satellite positioning systems are already known, such as for example the GPS system, the GLONASS system or the future GALILEO system. These systems include a satellite constellation in movement around the Earth. In a satellite positioning system, the location of a receiver, in other words the determination of its space coordinates, is carried out in a known manner by determining the propagation time of a specific hyperfrequency wave between each satellite and this receiver, with this propagation time used to determine the distance from the object to the satellite. The knowledge of the distance in relation to at least four satellites, as well as the position of the satellites themselves, is then used to determine the position of the receiver.

A first essential stage which determines the performances of the system is the stage for the acquisition of the signals from the satellites. In particular, this acquisition stage involves determining at the receiver concerned the pseudo-random codes which modulate signals from satellites, said to be “in view”, belonging to a constellation of positioning satellites and related to a reference time, generally called the “system time”. This in fact involves comparing the signals received from satellites in view to replica signals resulting from hypotheses on the system time and on the timing frequency of the satellites, in order to deduce the pseudo-random codes which modulate said received signals or in other words to synchronize the timing clock of the terminal and its frequency on the clock and the frequency of each satellite in view. To do this, correlation measurements are usually taken based on time and frequency hypothesis pairs.

Once the acquisition is made, a following stage determines the position of the receiver from the codes acquired and from navigation data, in particular contained in the signals received. These navigation data items can for example be satellite times, their transmission time and the ephemeris of the positioning satellite which sent them. This stage begins by determining, from the pseudo-random codes acquired, the propagation times for the signals between each of the satellites in view and the receiver, then using the navigation data contained in the signals and the propagation times, the distances between the receiver and the satellites are determined.

These techniques have well-known limitations. A first limitation relates to the acquisition phase. In this acquisition phase, a receiver must scan a data frequency range to lock a signal sent by a satellite. However, there is a relatively large uncertainty frequency band inherent to the satellite positioning system. This uncertainty can reach around 15 kHz and extends the acquisition time, a key performance factor for the system. This uncertainty is essentially due to three well-known factors. A Doppler effect due to the satellite movements, a Doppler effect due to the movements of the users and therefore the receivers, and lastly an uncertainty due to the error of the receiver local clock. In addition to this uncertainty for frequencies, there is also an uncertainty over the times involved in the phase for determining the receiver position. This time uncertainty depends on the frequency at which the pseudo-random code is sent by the satellites. It can reach 30 seconds, which implies in this case that it is necessary to wait for at least this duration to find out the position of a satellite. This frequency uncertainty and this time uncertainty therefore extend the acquisition time and degrade the sensitivity of the receivers.

These limitations are overcome using satellite radio navigation assistance techniques. Assisted radio navigation systems combine mobile telephony techniques with satellite positioning techniques, such as the A-GPS system for example, and more generally the A-GNSS systems. These systems combine a satellite positioning receiver with a mobile telephony terminal. They improve the sensitivity of the positioning receivers and the acquisition times. They do nonetheless have disadvantages in that they require the services of a mobile telephony operator, which in particular increases the cost of the services for the users.

One aim of the invention in particular is to resolve this disadvantage. To this effect, the aim of the invention is to provide a pre-location method to help locate a satellite radio navigation terminal using the services of a cellular communication network. Since the pre-location involves locating the terminal in at least one network cell, the method includes at least:
one formation phase (21, 22) for a database compiling location information items of the network cells transmitted by the cellular network terminals, wherein said database comprises, for each cell, at least one identifier and information item on the location thereof;
one pre-location phase (23) for the terminal according to the identifier thereof and information items contained in the database.

The database formation phase includes for example a stage for the retrieval of location information, a location information item for a terminal being transmitted to the database by this terminal with the identifier of the cell which contains it. In the pre-location phase, the identifier of the cell containing the terminal is for example compared with the identifiers stored in the database, the terminal being pre-located in the cell for which the identifier of the base is the same as the identifier.

In the event of an identifier containing the Cl digital identity of the cell and the LAC digital identity of a cell group including this cell, the pre-location phase has the advantage of comparing the LAC identity of the cell group with the LAC grouping identities stored in the database, with the terminal pre-located in a cell group for which the LAC identity is the same as the LAC grouping identity of its cell.

In a particularly beneficial implementation method, the database is stored in the terminal.

The invention also has the aim of providing a pre-location system for location help containing a mobile telephony terminal using the services of a cellular communication network, this terminal being equipped with a satellite radio navigation receiver. This system includes a database compiling location information items of the network cells transmitted by the cellular network terminals, wherein said database comprises, for each cell, at least one identifier and information item on the location thereof, with the terminal determining its pre-location depending on its identifier and the information items contained in the database.

A location information item of a terminal of the cellular communication network is for example sent by this terminal to the database, with the identifier of the cell which contains it.

For the pre-location calculation, the terminal compares for example the identifier of the cell containing the terminal with the identifiers stored in the database, with the terminal being pre-located in the cell for which the identifier of the base is the same as the identifier concerned.

The invention also has the aim of providing a mobile telephony terminal using the services of a cellular communication network, fitted with a satellite radio navigation receiver. This terminal contains a database compiling location information items of the network cells transmitted by the terminal, wherein said database comprises, for each cell, at least one identifier and information item on the location thereof, with the terminal determining its pre-location depending on its identifier and the information items contained in the database.

The terminal provides, for example, an information item on its location to the database with the identifier of the cell which contains it. For the pre-location calculation, it compares for example the identifier of the cell containing the terminal with the identifiers stored in the database, with the terminal being pre-located in the cell for which the identifier of the base is the same as the identifier concerned.

Other characteristics and advantages of the invention will become clear through the following description, produced with regard to attached drawings which represent:

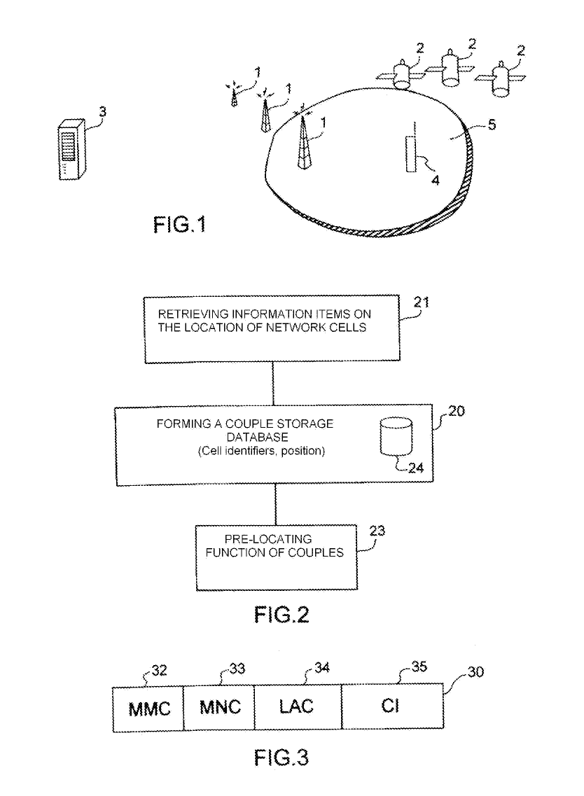

FIG. 1, an illustration of the operating principle of an assisted satellite radio navigation system;

FIG. 2, an example of implementation of the method according to the invention;

FIG. 3, a representation of a cell identifier in a cellular communication network used by the invention.

FIG. 1 shows by way of example the principle for an assisted satellite radio navigation system which will be called A-GNSS in the rest of the document, standing for “Assisted Global Navigation Satellite System”. The system shown in FIG. 1 contains a cellular mobile communications network materialized by base stations 1 and a satellite positioning network materialized by a satellite constellation 2. In the cellular communication network, each base station is associated in a known manner with a spatial cell 5. The cellular communication network also contains an assistance server 3 communicating with the base stations 2. This assistance server 3 contains a navigation receiver able to permanently receive the satellite signals 2 and to store them in its database for a pre-determined duration. A mobile terminal 4 is located inside a communication cell 5 associated with a base station. This mobile terminal is able to receive at least signals containing navigation data of the satellite positioning network and assistance server data. This terminal is for example a mobile telephony terminal fitted with a satellite navigation receiver, for example a GPS receiver. In the rest of the document, terminal and mobile telephone will be used indifferently. This terminal can send the assistance server 3 a message asking it to send assistance data. The message requiring assistance is sent in the same way as standard data via the cellular communication network. It contains the identifier of the mobile telephone 4 concerned. The assistance data provided by the assistance server 3 gives the satellite navigation receiver at least the position of the mobile telephony terminal 4 which contains it. It can also provide the time reference of the satellite constellation and the satellite ephemeris. All these data items allow the receiver to reduce the time to acquire the signals sent by the satellites and the time to determine their positions, and therefore its position. An example of the implementation of an A-GNSS system is in particular described in the French patent request published under the number 2 858 510.

In such a system, the assistance data contain a pre-location information item of a terminal 4 deduced from the position of the cell 5 in which it is located during the transmission of the message requiring assistance. This information item is in fact transmitted by the mobile telephony operator, which knows the installation of its base stations. The code of the base station concerned is inserted in each transaction, which allows the operator to identify and locate the base station, and therefore the cell in which the terminal requiring assistance is located, with the location of the cell finally giving the pre-location for the A-GNSS system. In certain cases it will be beneficial for a user, or more generally for the whole of the A-GNSS system, not to require the services of a mobile telephony operator. This is the case for at least two specific reasons:
to be able to access the A-GNSS services or provide an A-GNSS service without the contribution of a mobile telephony operator, and therefore without paying the associated taxes for the assistance service;
to get away from the fact that it is impossible for an operator to reliably retain a database relating to the base stations since the stations can also be mobile.

FIG. 2 shows the stages possible for the implementation of a method according to the invention. In this implementation we find the satellite positioning network 2 and the cellular communication network 1, as shown in FIG. 1, but use is no longer made of an assistance server 2 operated by a mobile telephony operator. The pre-location according to the invention uses a database containing location information items of the cells 5 of the cellular communication network maintained by the location information items provided by the users themselves. This is a collaborative process where each user contributes to the completion of the database.

The method contains a phase for the formation of the database compiling location information items of the network cells transmitted by the terminals 4 of the cellular network. This database comprises, for each cell, at least one identifier and the location thereof. The method also includes a pre-location phase 23 of a terminal according to the identifier thereof and information items contained in the database. The first phase can be implemented in two stages, for example. In a first stage 21, the location information items of the network cells are retrieved. The location of a cell 4 is in fact determined by the location of its base station 3. It is nonetheless possible to choose another location point.

In a second stage 22, the database 24 is created. This database stores the position and location information items of each cell. It stores these data items for example in the form of couple records, with each couple containing an identifier for a cell and the position thereof. This position is for example the position of the base station associated with the cell. This second stage 22 is followed by the pre-location phase 23.

The database 24 is for example stored in a server accessible via the Internet network. When users request assistance for the location, the request contains an identifier of the cell 5 in which their mobile telephone 4 is located. The mobile telephone can easily access this identifier since it is inserted in each transaction carried out with the base station associated with its cell.

FIG. 3 shows an example of a cell identifier 5 of a cellular communication network. More specifically, FIG. 3 shows an example of digital identity 30 of a cell. Such a digital identity is inserted in each transaction message between a mobile telephone 4 and the base station with which it communicates. The digital identity 30 contains 4 fields. A first field 31 identifies the country of the network and therefore contains a word which indicates a country code. This is generally named MCC, standing for Mobile Country Code. A second field 32 identifies the network and includes the network code. This is generally named MNC, standing for Mobile Network Code. A third field 33 identifies a geographical area grouping several cells, including the cell itself, and includes a code identifying this area. This is generally named LAC, standing for Location Area Code. Lastly, a fourth field 34 identifies the cell itself inside the cellular network through a code, generally named Cl, standing for Cell Identity. This code in fact represents the actual identity of the cell.

Couples (cell identifier, position) are created based on the position information given by a mobile telephone obtained using its satellite navigation receiver. This position is sent through a message to the server which stores it with the cell identifier. The retrieval stage 21 of the location information is therefore carried out by sending position data calculated by the mobile telephone receivers to the server. Then stage 22 for creation of the base is carried out for each cell, by saving the position information of the mobile telephone and therefore of the cell which contains it.

Beneficially, an identifier 31 of the type in FIG. 3 allows several pre-location levels. If the position of a cell has already been registered, a user who requests assistance from the server containing the database 24 can determine the position of the cell thanks to its identifier 30 which will be associated with the position of the cell in the base. This position of the cell will give its pre-location, with the accuracy given by the size of the cell itself. This pre-location is carried out in stage 23 of the pre-location, where the mobile telephone retrieves the position of the cell in the base from the couple (cell identifier, position), for example. To do this, the mobile telephone searches the whole database 24 until it detects by comparison the identifier of its cell, in particular the Cl digital identity of the latter.

If the cell in which the user is located has not yet been registered, users cannot yet pre-locate themselves using the database 24, they can only enhance the base. However, if users are in a cell neighboring a registered cell, they can pre-locate themselves, albeit less accurately. In fact in this case, the cell in which the user is located can be identified by the field 33 coding an area which groups several cells, including this cell in particular. This means that the LAC code of the cell concerned is common to other cells for which the position is already registered. Through the LAC code of the cell in which they are located, users can therefore determine their position, the accuracy being that of the area identified by this LAC code. In this case the pre-location stage 23 can be completed, when the mobile telephone has not detected the Cl identity of its cell, by a search for the LAC code of its cell which is already registered. This example shows the advantage that depending on the case, the identifier used for the pre-location may be the digital identity of a cell but also the digital identity, or LAC code, of the cell group which contains it.

It has been indicated that the database 24 could for example be stored in a server accessible via the Internet. It also has the advantage that it can be stored in the mobile telephone 4 itself. In this case, each mobile telephone fills its database 24 over the course of the movements and position searches it carries out. The base no longer has a collaborative aspect, but it is immediately accessible and independent. A memory installed in a mobile telephone can support such a database. In fact, if we consider the case of a country with a surface area equivalent to that of France, for example, a mobile telephone network contains around 10,000 cells. This memory can easily contain 10,000 records. Assuming that each record occupies 6 bytes, for example, the space required is only 60,000 bytes.

If the database is not stored in the mobile telephones, it can therefore be stored in a server accessible by these telephones. In this case a pre-location system according to the invention contains for example this server and at least one mobile telephone equipped with a satellite radio navigation receiver.

The satellite positioning system used can for example be the GPS system or the future GALILEO system.

Once the pre-location is carried out, the location calculations can be carried out in the mobile telephones or in the server. If the location calculation is carried out in a mobile telephone, this can re-send the server its exact position.

The implementation of the invention has been described with a mobile telephone, but it can of course be implemented with all types of mobile telephony terminals.

1. Pre-location method for help locating a satellite radio-navigation terminal (2) using the services of a cellular communication network (3), characterized in that since the pre-location involves locating the terminal in at least one network cell, it contains at least:
one formation phase (21, 22) for a database (24) compiling location information items of the network cells transmitted by the cellular network terminals (4), wherein said database comprises, for each cell, at least one identifier (30) and information item on the location thereof;
one pre-location phase (23) for the terminal according to the identifier thereof and information items contained in the database.

2. Method according to claim 1, characterized in that the database formation phase contains a retrieval stage (21) for the location information items, a location information item for a terminal (4) being transmitted to the database (24) by this terminal with the identifier (30) of the cell (5) which contains it.

3. Method according to claim 1, characterized in that in the pre-location phase, the identifier (30) of the cell (5) containing the terminal is compared with the identifiers stored in the database (24), the terminal being pre-located in the cell for which the identifier of the base is equal to the identifier (30).

4. Method according to claim 3, characterized in that an identifier containing the CI digital identity (34) of the cell (5) and the LAC identity (33) of a cell group including this cell (5), the pre-location phase compares the LAC identity (33) of the cell group (5) with the LAC grouping identities stored in the database, with the terminal pre-located in a cell group for which the LAC identity is the same as the LAC grouping identity (33) of its cell.

5. Method according to claim 1, characterized in that the database (24) is stored in the terminal (4).

6. Pre-location system for location assistance containing a mobile telephony terminal using the services of a cellular communication network (3), said terminal (4) fitted with a satellite radio navigation receiver (2), characterized in that it contains a database (24) compiling location information items of the network cells transmitted by the cellular network terminals, wherein said database comprises, for each cell, at least one identifier (30) and information item on the location thereof, with the terminal (4) determining its pre-location depending on its identifier and the information items contained in the database.

7. System according to claim 6, characterized in that a location information item for a cellular communication network terminal is transmitted by this terminal to the database (24) with the identifier (30) of the cell (5) which contains it.

8. System according to claim 6, characterized in that for the pre-location calculation, the terminal (4) compares the identifier (30) of the cell (5) containing the terminal (4) with the identifiers stored in the database (24), with the terminal being pre-located in the cell for which the identifier of the base is the same as the identifier (30).

9. System according to claim 8, characterized in that an identifier containing the CI digital identity (34) of the cell (5) and the LAC digital identity (33) of a cell group including this cell (5), for the pre-location calculation, the terminal (4) compares the LAC identity (33) of the group of its cell (5) with the LAC grouping identities stored in the database, with the terminal pre-located in a cell group for which the LAC identity is the same as the LAC grouping identity (33) of its cell.

10. System according to claim 6, characterized in that the database (24) is stored in the terminal (4).

11. Mobile telephony terminal using the services of a cellular communication network, fitted with a satellite radio navigation server, characterized in that it contains a database (24) compiling location information items of the network cells transmitted by the terminal, wherein said database comprises, for each cell, at least one identifier (30) and information item on the location thereof, with the terminal (4) determining its pre-location depending on its identifier and the information items contained in the database.

12. Terminal according to claim 11, characterized in that it provides an information item on its location to the database (24) with the identifier (30) of the cell (5) which contains it.

13. Terminal according to claim 10, characterized in that for the pre-location calculation, it compares the identifier (30) of the cell (5) containing the terminal (4) with the identifiers stored in the database (24), with the terminal pre-located in the cell for which the identifier of the base is the same as the identifier (30).

14. System according to claim 8, characterized in that an identifier containing the CI digital identity (34) of the cell (5) and the LAC digital identity (33) of a cell group including this cell (5), for the pre-location calculation, the terminal (4) compares the LAC identity (33) of the group of its cell (5) with the LAC grouping identities stored in the database, with the terminal pre-located in a cell group for which the LAC identity is the same as the LAC grouping identity (33) of its cell.
